(19) United States
(12) Patent Application Publication
(10) Pub. No.: US 2005/0285832 A1
(43) Pub. Date: Dec. 29, 2005

(54) Computer system

(75) Inventors: Seung-gi Shin, Gyeonggi-do (KR); Shung-hyun Cho, Gyeonggi-do (KR); Hae-jin Hwang, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/159,113

(22) Filed: Jun. 23, 2005

(30) Foreign Application Priority Data
Jun. 24, 2004 (KR) 10-2004-0047875

(51) Int. Cl. G09G 3/36

(52) U.S. Cl. 345/87

(57) ABSTRACT

A computer system including a display having a digital receiving connector receiving a digital video signal according to a predetermined digital video interface, and a display module displaying a picture based on the digital video signal received from the digital receiving connector, a computer separated from the display and including a digital transmitting connector based on the digital video interface and a graphic controller outputting the digital video signal through the digital transmitting connector, and a digital video cable including a first video connector connected to the digital receiving connector and a second video connector connected to the digital transmitting connector, and through which the digital video signal is transmitted from the computer to the display. With this configuration, the present invention provides a computer system, in which a computer and a display are simplified in configurations, and loss in a video signal is decreased.

### CROSS-REFERENCE TO RELATED APPLICATIONS

This application claims the priority benefit of Korean Patent Application No. 2004-0047875, filed on Jun. 24, 2004, in the Korean Intellectual Property Office, the disclosure of which is incorporated herein by reference.

### BACKGROUND OF THE INVENTION

1. Field of the Invention

Embodiments of the present invention relate to a computer system, and more particularly, to a computer system in which a computer and a display are simplified and the loss in a video signal is decreased.

2. Description of the Related Art

Recently, analog and digital type interfaces have been used together to process video signals in an LCD device. Here, the analog type interface has an advantage that it can allow a CRT (cathode ray tube) display to be directly substituted for the LCD device. Further, the digital type interface has an advantage in picture quality due to impedance matching and the like of the LCD device.

The digital type interfaces for the LCD device have widely used a TMDS (transmission minimized differential signaling) type interface and an LVDS (low voltage differential signaling) type interface. Thus, manufacturers have manufactured graphic processors, used in graphic cards of a computer, to support the digital type interface outputting a TMDS digital video signal or a LVDS type digital video signal (hereinafter, referred to as “LVDS signal”). Here, a DVI (digital visual interface) connector has been used in transmitting the digital video signal from the computer to the display, wherein the DVI connector is based on a VESA (video electronics standard association) standard.

FIG. 1 is a control block diagram of a conventional computer system. As shown in FIG. 1, a computer system includes a computer 100a provided with a graphic processor 111a to output a digital video signal, and an LCD device 300a provided with an LCD module 130a supporting the LVDS type interface.

Here, the computer 100a outputs an analog video signal to the LCD device 300a. Correspondingly, the computer 100a includes a D-Sub transmitting connector 120a supporting one of the analog type interfaces, and the LCD device 300a includes a D-Sub receiving connector 140a connected to the D-Sub transmitting connector 120a.

The D-Sub transmitting connector 120a of the computer 100a and the D-Sub receiving connector 140a of the LCD device 300a can be connected to each other through a D-Sub video cable 500a.

Here, the digital video signal output from the graphic processor 111a is converted into the analog video signal through an RGB (red, green, blue) transmitter 112a, and the analog video signal is output from the D-Sub transmitting connector 120a to the LCD device 300a via the D-Sub video cable 500a.

The analog video signal received through the D-Sub receiving connector 140a of the LCD device 300a is then converted into the LVDS signal through a converter 150a and transmitted to the LCD module 130a.

FIG. 2 is a control block diagram of another conventional computer system. In this computer system, a graphic processor 111b of a computer 100b outputs an LVDS signal, with the LCD module 130b of an LCD device 300b supporting an LVDS type interface.

The computer 100b can output a TMDS type digital video signal (hereinafter, referred to as “TMDS signal”) to the LCD device 300b.

Correspondingly, the computer main body 100b includes a DVI transmitting connector 120b to transmit the TMDS signal to the LCD device 300b, with the LCD device 300b including a DVI receiving connector 140b connected to the DVI transmitting connector 120b.

Here, the DVI transmitting connector 120b of the computer 100b and the DVI receiving connector 140b of the LCD device 300b are connected to each other through a DVI video cable 500b.

The LVDS signal output from the graphic processor 111b is converted into a TMDS signal through a TMDS transmitter 112b, with the TMDS signal being transmitted to the LCD device 300b via the DVI transmitting connector 120b.

Then, the TMDS signal received in the LCD device 300b, through the DVI receiving connector 140b, is converted into a LVDS signal by a converter 150b, and then transmitted to the LCD module 130b.

However, in these conventional computer systems, the LCD device supporting the digital type interface, e.g., the TMDS type interface or the LVDS type interface, has to process the digital video signal transmitted from the graphic processor 111a or 111b to the LCD module 130a or 130b throughout various signal-converting processes. Therefore, losses arise in the video signal during each signal-converting process, and thus picture quality displayed on the LCD module 130a or 130b is deteriorated.

Particularly, in the case of the analog type interface connector such as the D-Sub transmitting and receiving connectors 120a and 140a, even though the graphic processor 111a and the LCD module 130a support the digital type interface, redundant processes are needed for converting the digital video signal transmitted to the graphic processor 111a into the analog video signal in the computer 100a, and for converting the analog video signal into the digital video signal in the LCD device 300a. Such redundant processes not only cause losses in the video signal but also requires the computer 100a to include a D/A converter such as the RGB transmitter 112a and the display 300a to include an A/D converter 150a, thereby increasing production costs for both the computer 100a and the LCD device 300a, as well as enlarging the required component installation space.

In the case where the analog video signal is input to the LCD device 300a, there is further needed a scaling process. Therefore, the LCD device 300a is also in need of a scaler chip for the scaling process, and thus production costs of the LCD device 300a are increased and the component installation space thereof is increased.

### SUMMARY OF THE INVENTION

Accordingly, it is an aspect of the present invention to provide a computer system, and corresponding method, in which a computer and a display have simplified configurations, and video signal loss is decreased.

To achieve the above and/or other aspects and advantages, embodiments of the present invention include a computer system including a display having a digital receiving connector to receive a digital video signal, according to a predetermined digital video interface, and a display module displaying a picture directly from the received digital video signal, a computer, separated from the display, having a digital transmitting connector, based on the predetermined digital video interface, and a graphic controller outputting the digital video signal through the digital transmitting connector, and a digital video cable, having a first video connector connected to the digital receiving connector and a second video connector connected to the digital transmitting connector, to transmit the digital video signal from the computer to the display.

The digital video interface may be one of an LVDS (low voltage differential signaling) interface and a TMDS (transmission minimized differential signaling) interface. Further, the graphic controller may include a graphic processor outputting an analog video signal, and a digital transmitter converting the analog video signal output from the graphic processor into the digital video signal. The computer may also include a display controller to control a display state of the picture displayed on the display module, and the display controller may control the display state of the picture displayed on the display module by adjusting characteristics of the digital video signal output from the graphic controller.

Here, the display may further include a power receiving connector to receive driving power for driving the display module, the computer may further include a power supplying connector connected to the power receiving connector and a display power supply to supply the driving power to the display through the power supplying connector, and
the computer system may further include a power cable having a first power connector connected to the power receiving connector and a second power connector connected to the power supplying connector supplying the driving power between the computer to the display.

The display module may include an LCD panel, a panel driver driving the LCD panel using the digital video signal, a backlight illuminating the LCD panel, and an inverter controlling light of the backlight based on a control signal from the computer, and the display controller may control one of the graphic controller and the display power supply to output the control signal. Similarly, the display module may include an LCD panel, a panel driver driving the LCD panel using the digital video signal, a backlight illuminating the LCD panel, and an inverter controlling an intensity of light from the backlight based on the driving power supplied from the computer, with the display controller controlling the driving power supplied from the display power supply to the inverter.

The display may include a memory storing display identification information about the display, and the computer and the display may include at least two data lines to transmit the display identification information from the display to the computer.

In addition, the display identification information may include EDID (extended display identification) data.

The display controller may also control the display state based on the display identification information received from the display. The data line may be allocated to corresponding pins of the digital transmitting connector and the digital transmitting connector, and the computer and the display may include a data line to transmit information about a type of the display from the display to the computer. The display controller may control the display state of a picture displayed on the display module according to the type of the display identified through the data line. The data line may further be allocated to corresponding pins of the digital transmitting connector.

To achieve the above and/or other aspects and advantages, embodiments of the present invention include a computer system including a display having a low voltage differential signaling (LVDS) digital receiving connector to receive a LVDS digital video signal and a display module displaying a picture directly from the received LVDS digital video signal, a computer, separated from the display, having an LVDS digital transmitting connector and a graphic controller outputting a corresponding digital video signal for the LVDS digital transmitting connector.

To achieve the above and/or other aspects and advantages, embodiments of the present invention include a computer system including a display having a transmission minimized differential signaling (TMDS) digital receiving connector to receive a TMDS digital video signal and a display module displaying a picture directly from the TMDS received digital video signal, a computer, separated from the display, having a TMDS digital transmitting connector and a graphic controller outputting a corresponding digital video signal for the TMDS digital transmitting connector.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIGS. 1 and 2 are block diagrams of conventional computer systems;

FIG. 3 illustrates a computer system, according to an embodiment of the present invention;

FIG. 4 is a block diagram of a computer system, according to an embodiment of the present invention;

FIG. 5 is a block diagram of a computer system, according to another embodiment of the present invention;

FIG. 6 is a block diagram of a computer in a computer system, according to still another embodiment of the present invention;

FIG. 7 is a block diagram of a display in a computer system, according to an embodiment of the present invention; and

FIGS. 8 and 9 illustrate pin structures of an LVDS unified connector, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to like elements throughout. The embodiments are described below in order to explain the present invention by referring to the figures.

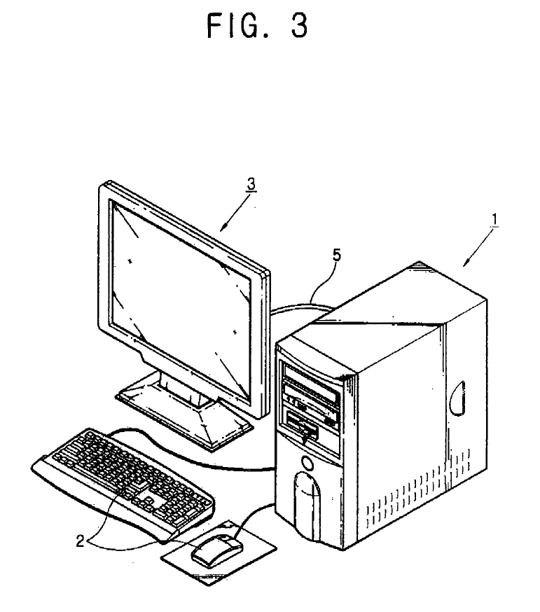

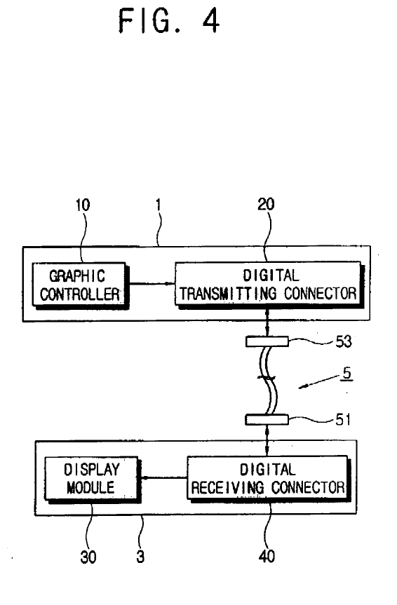

As shown in FIGS. 3 and 4, a computer system, according to an embodiment of the present invention includes a computer 1 outputting a digital video signal, a display 3 displaying a picture based on the digital video signal from the computer 1, and a digital video cable 5 through which the digital video signal is transmitted from the computer 1 to the display 3. Further, the computer system includes an input unit 2 such as a keyboard, a mouse, etc., for example.

The computer 1 may include a graphic controller 10 outputting the digital video signal, according to a digital video interface, and a digital transmitting connector 20 transmitting the digital video signal from the graphic controller 10 to the display 3.

The display 3 includes a digital receiving connector 40, receiving the digital video signal, and a display module 30 displaying a picture based on the digital video signal received from the digital receiving connector 40.

The digital video cable 5 includes a first video connector 51 connected to the digital receiving connector 40 of the display 3, and a second video connector 53 connected to the digital transmitting connector 20 of the computer 1. Thus, the digital video signal is transmitted from the computer 1 to the display 3 via the digital video cable 5.

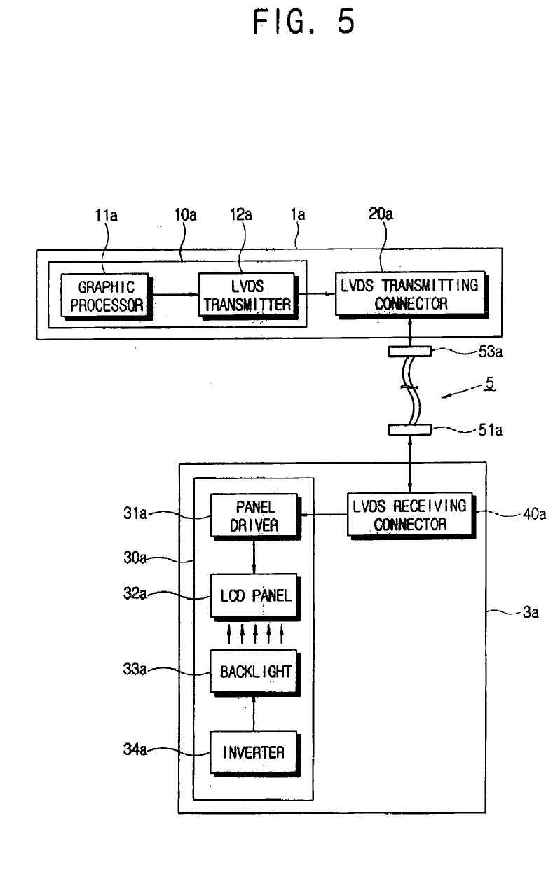

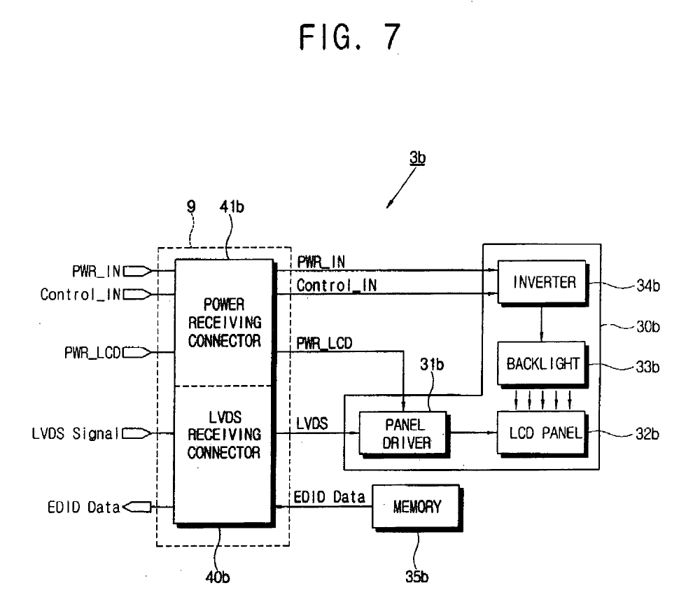

Hereinbelow, an LVDS type interface will be described, as an example of the digital video interface, and LCD devices 3a and 3b (referring to FIGS. 5 and 7) will be described as examples of the display 3. Correspondingly, the digital video signal, the digital transmitting connector 20, and the digital receiving connector 40 will be regarded, herein, as an LVDS signal, an LVDS transmitting connector 20a, an LVDS receiving connector 40a, respectively. Further, the display module 30 of the LCD display 3a will be regarded as an LCD module 30a, for example.

FIG. 5 is a block diagram of a computer system, according to an embodiment of the present invention. As shown therein, the computer system includes a computer 1a outputting an LVDS signal, the LCD device 3a displaying a picture based on the LVDS signal received from the computer 1a, and an LVDS video cable 5a through which the LVDS signal is transmitted from the computer 1a to the LCD device 3a.

The computer 1a includes a graphic controller 10a outputting the LVDS signal, and an LVDS transmitting connector 20a transmitting the LVDS signal from the graphic controller 10a to the LCD display 3a. Here, the graphic controller 10a and the LVDS transmitting connector 20a can be integrated into a graphic card, by way of example, mounted into a slot (not shown), e.g., an AGP (accelerated graphics port) slot provided in a main board (not shown) of the computer 1a.

According to this embodiment of, the graphic controller 10a includes a graphic processor 11a outputting an analog video signal and an LVDS transmitter 12a converting the analog video signal output from the graphic processor 11a into the LVDS signal. Here, as the graphic controller 10a, the graphic processor 11a and the LVDS transmitter 12a can be formed as a single chip set or as separate chip sets, and mounted to the graphic card, for example.

The LCD module 30a supports the LVDS type interface, and the LCD module 30a includes an LCD panel 32a on which a picture is displayed, and a panel driver 31a driving the LCD panel 32a. Further, the LCD module 30a includes a backlight 33a illuminating the LCD panel 32a, and an inverter 34a turning on/off the backlight 33a and controlling light intensity. Here, the panel driver 31a drives the LCD panel 32a to operate based on the LVDS signal received through the LVDS receiving connector 40a.

The LVDS video cable 5a includes a first video connector 51a connected to the LVDS receiving connector 40a of the LCD device 3a and a second video connector 53a connected to the LVDS transmitting connector 20a of the computer 1a.

Meanwhile, the LVDS transmitting connector 20a and the LVDS receiving connector 40a, according to this embodiment, can have a pin structure (to be described later) for transmitting the LVDS signal.

With this configuration, the computer 1a transmits the LVDS signal output from the graphic controller 10a to the LVDS video cable 5a through the LVDS transmitting connector 20a. Then, the LVDS signal is transmitted to the LCD device 3a via the LVDS video cable 5a. Further, the LCD device 3a directly receives the LVDS signal through the LVDS receiving connector 40a, and thus the LCD module 30a directly receives the LVDS signal through the LVDS receiving connector 40a and displays a picture based on the LVDS signal.

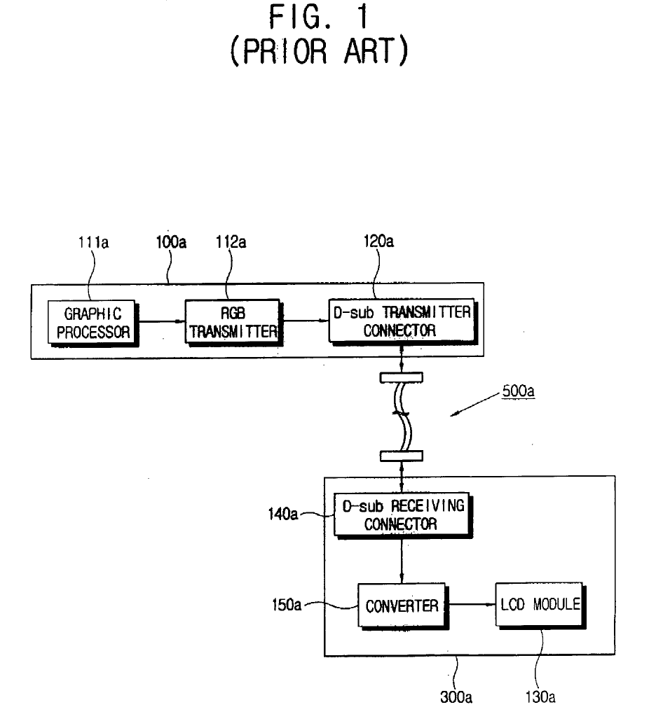

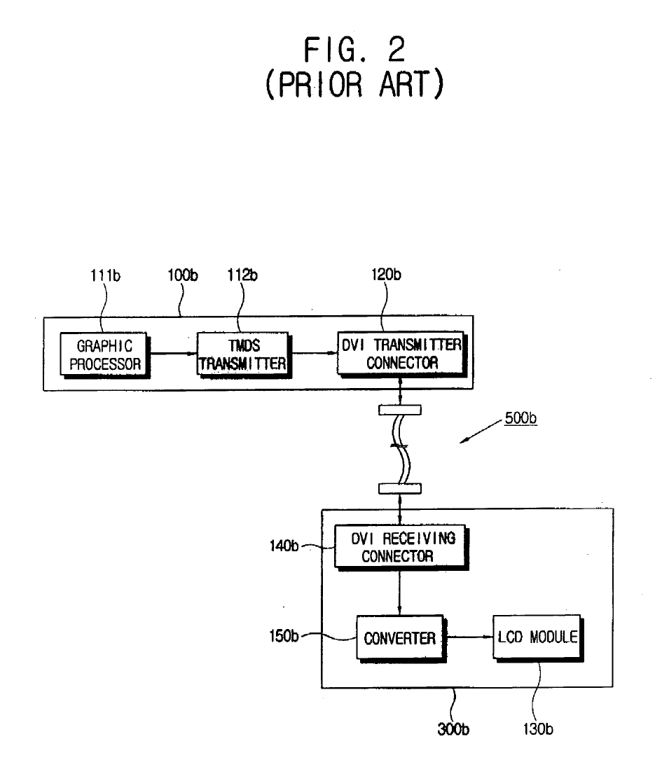

Hence, as compared with conventional computer systems (e.g., FIGS. 1 and 2) in which the signal-converting processes are respectively performed in both the computer s100a and 100b and the LCD devices 300a and 300b, the LCD device 3a of the computer system can directly receive the LVDS signal, so that there is no loss from the signal-converting process. Further, as compared with the conventional computer system, where the computers 100a and 100b and the LCD devices 300a and 300b include the chips such as the converters 112a, 112b, 150a, and 150b, or the like, used in the signal-converting processes, the computer 1a and the LCD device 3a of the computer system, according to an embodiment of the present invention, does not need the chips such as the conventional converter or the like, so that these corresponding configurations of the computer 1a and the LCD device 3a are simplified and production cost thereof can be lower than conventional systems.

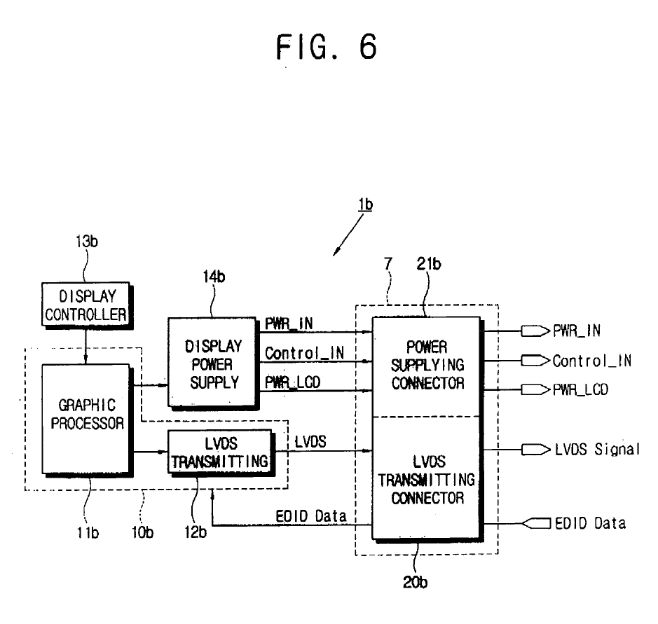

FIG. 6 is a block diagram of a computer in a computer system according to another embodiment of the present invention, with FIG. 7 illustrating control block diagram of a display in such a computer system, according to an embodiment of the present invention. Hereinbelow, like reference numerals as in the above embodiments refer to like elements throughout, and repetitive descriptions will be avoided where possible.

According to this embodiment of the present invention, a computer 1b may further include a display controller 13b to control a display state of a picture displayed on an LCD module 30b. Here, the display controller 13b can adjust characteristics of a digital video signal output from a graphic controller 10b, thereby controlling the display state of a picture displayed on the LCD module 30b.

For example, the display controller 13b can adjust a resolution of the LVDS signal itself output from the graphic controller 10b, thereby regulating the resolution of a picture displayed on the LCD module 30b. In the same way, the display controller 13b can adjust contrast, white balance, color temperature, position of a picture displayed on the LCD module 30b. Thus, to adjust the display state of a picture displayed on the display module 30b, according to this embodiment of the present invention, an OSD (on screen display) button, an OSD generator, a scaler, and a microcomputer controlling the same, as used in the conventional LCD devices, are not needed. Hence, the LCD device 3b can have simple configurations with reduced production costs.

According to an embodiment of the present invention, the computer 1b includes a display power supply 14b to supply driving power PWR_IN and PWR_LCD to the LCD device 3b, and a power supplying connector 21b through which the driving power PWR_IN and PWR_LCD are supplied from the display power supply 14b to the LCD device 3b. Correspondingly, the LCD device 3b includes a power receiving connector 41b connected to the power supplying connector 21b, thereby receiving the driving power PWR_IN and PWR_LCD.

The computer system may further include a power cable (not shown) through which the driving power PWR_IN and PWR_LCD are supplied from the power supplying connector 21b of the computer 1b to the power receiving connector 41b of the LCD device 3b. Here, the power cable includes a first power connector connected to the power receiving connector 41b of the LCD device 3b, and a second power connector connected to the power supplying connector 21b of the computer 1b.

Thus, the LCD device 3b, according to this embodiment of the present invention, does not need a separate power supply such as a DC/DC converter or the like to receive the driving power PWR_IN and PWR_LCD, such that the LCD device 3b has a more simplified configuration with lower production costs.

According to an embodiment of the present invention, each of the power supplying connector 21b and the power receiving connector 41b may include an inverter power line to supply the driving power PWR_IN, for an inverter 34b, and a panel power line to supply the driving power PWR_LCD, for a panel driver 31b and an LCD panel 32b. Also, a power cable can be provided in correspondence to the power supplying connector 21b and the power receiving connector 41b.

Meanwhile, the display controller 13b can control the brightness of a picture displayed on the LCD panel 32b by adjusting voltage of the driving power PWR_IN of the inverter 34b, as output from the display power supply 14b. At this time, the inverter 34b can adjust light intensity of the backlight 33b in correspondence to the voltage of the driving power PWR_IN.

Further, the display controller 13b may output a control signal Control_IN to the inverter 34b, through control signal lines provided in the power supplying connector 21b and the power receiving connector 41b, thereby adjusting the brightness of a picture displayed on the LCD panel 32b. In this case, the display controller 13b can control the display power supply 14b to output the control signal Control_IN, as shown in FIG. 6. The display controller 13b may control the graphic controller 10b to output the control signal.

Similarly, the display controller 13b can output the control signal Control_IN to the inverter 34b through control signal lines provided in the LVDS transmitting connector 20b and the LVDS receiving connector 40b, thereby adjusting the brightness of a picture displayed on the LCD panel 32b. In this case, the display controller 13b can control the graphic controller 10b or the display power supply 14b to output the control signal Control_IN.

According to an embodiment of the present invention, the LCD device 3b may further include a memory 35b to store display identification information. Here, the display identification information stored in the memory 35b can be transmitted to the computer 1b through a data line provided in the LVDS receiving connector 40b. In this case, the LVDS transmitting connector 20b of the computer 1b can be provided with a data line corresponding to the data line of the LVDS receiving connector 40b, and the data line of the LVDS transmitting connector 20b can be connected to the graphic controller 10b, e.g., to a graphic processor 11b.

The display identification information stored in the memory 35 may include EDID (extended display identification) data according to a VESA standard. In this case, the EDID data is transmitted from the LCD device 3b to the computer 1b through two data lines, for example.

The display controller 13b can control the display state of a picture displayed on the LCD device 3b based on the EDID data received from the LCD device 3b. For example, the resolution of the LVDS signal output from the graphic controller 10b can be determined according to the resolution of the LCD device 3b included in the EDID data.

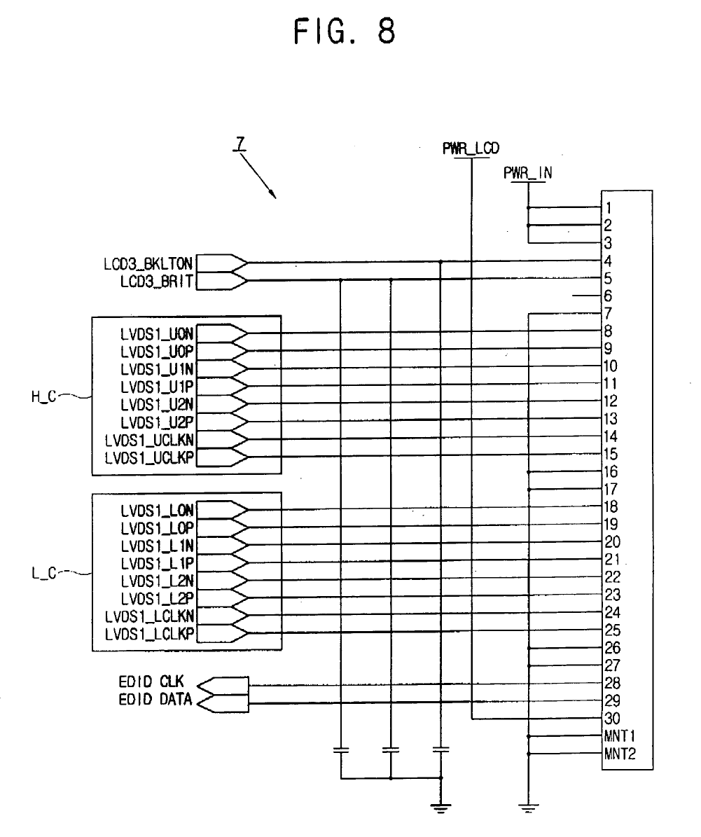

FIG. 8 is a view illustrating a pin structure of an LVDS transmitting connector 20b, according to an embodiment of the present invention. Here, the LVDS transmitting connector 20b and the power supplying connector 21b can be unified as a single connector (hereinafter, referred to as “LVDS transmitting unified connector”) by way of example, but not limited therto, and may be respectively provided as separate connectors. Further, the LVDS receiving connector 40b and the power receiving connector 41b are provided in correspondence to the LVDS transmitting connector 20b and the power supplying connector 21b, respectively, and can be integrally formed as an LVDS receiving unified connector 9 (referring to FIG. 7).

The LVDS transmitting unified connector 7 can include a signal line having at least one channel to transmit the LVDS signal. Here, FIG. 8 illustrates that the signal line has two channels H_C and L_C for transmitting the LVDS signal, wherein the computer system, according to an embodiment of the present invention, can transmit the LVDS signal through one of the channels as necessary.

Referring to FIG. 8, the channels of H_C and L_C can be allocated to the 8^{th} through 15^{th} pins and 18^{th} through 25^{th} pins, respectively, as an example. Here, the signal line for the LVDS signal can have a pin structure according to a IEEE 1596.3 standard, with descriptions thereof being omitted in this specification for brevity.

Further, the power supplying connector 21b can be allocated to the 1^{st} through 3^{rd} pins and a 30^{th} pin of the LVDS transmitting unified connector 7. Here, the 1 st through 3^{rd} pins of the LVDS transmitting unified connector 7 can be used for supplying the driving power PWR_IN, for the inverter 34b, and the 30^{th} pin of the LVDS transmitting unified connector 7 can be used for supplying the driving power PWR_LCD for the panel driver 31b and the LCD panel 32b.

Two pins of the LVDS transmitting unified connector 7, e.g., 28^{th} and 29^{th} pins (refer to FIG. 8) can be allocated to the data line for transmitting the aforementioned EDID data from the memory 35b of the LCD device 3b to the computer 1b.

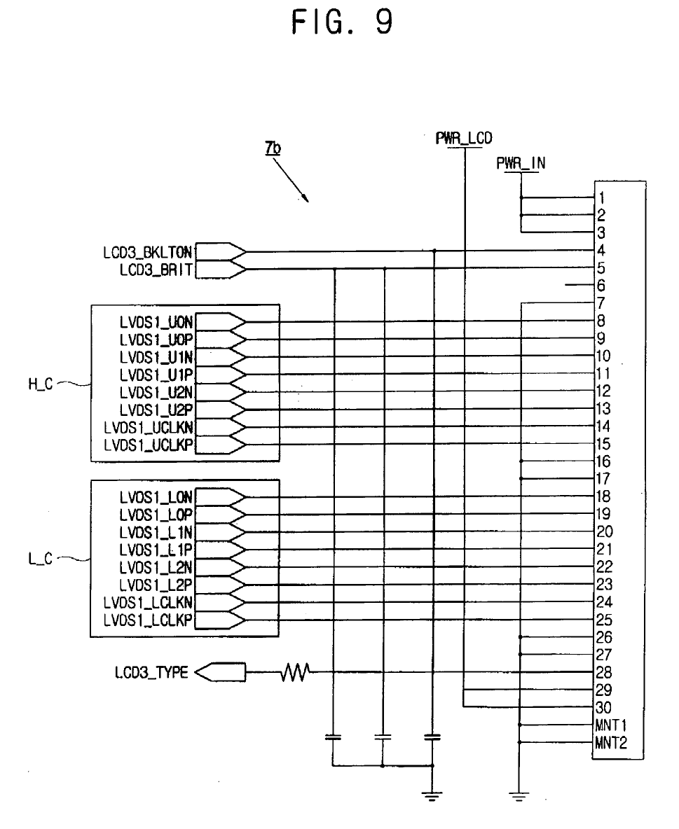

FIG. 9 illustrates another pin structure for a LVDS transmitting unified connector 7b, according to an embodiment of the present invention. Hereinbelow, like reference numerals in FIG. 9, as the LVDS transmitting unified connector 7 of FIG. 8, refer to like elements throughout, and repetitive descriptions will be avoided as necessary.

As shown in FIG. 9, in the pin structure of the LVDS transmitting unified connector 7b, according to an embodiment of the present invention, one pin can be allocated to the data line. Here, the LCD device 3b transmits a signal LCD3_TYPE, having a logical value corresponding to the types of the LCD device 3b, to the computer 1b through the data line of the LVDS transmitting unified connector 7b. In the case of the LCD device 3b, according to an embodiment of the present invention, information about differing types of resolution can also be provided, corresponding to the respective logical values.

Here, the display controller 13b of the computer 1b can detect the logical value LCD3_TYPE, through the data line of the LVDS transmitting unified connector 7b, thereby determining the type of the LCD device 3b, e.g., manufacturer, model, or signaling information. For example, where the information about the type of LCD device 3b is set according to information about the resolution of the LCD device 3b, the display controller 13b can control the resolution of the LVDS signal output from the graphic controller 10b based on the logical value LCD3_TYPE, of the data line of the LVDS transmitting unified connector 7b.

In the foregoing embodiment, the LVDS interface has been described as the digital video interface, by way of example. However, a TMDS interface may be used. In the case of the TMDS interface, the digital transmitting connector 20 and the digital receiving connector 40, according to an embodiment of the present invention, can be provided as connectors supporting the TMDS interface, and preferably has a DVI connector structure according to the VESA standard.

In the foregoing embodiment, the LCD device 3a and 3b have been described as the display 3, by way of example. However, the display 3 may also be applied to other display types supporting a digital video interface such as the LVDS interface or the TMDS interface. For example, the display 3 may be applied to a PDP display, an EL (electron luminescent) display, etc., supporting the digital video interface.

Thus, a computer system, according to an embodiment of the present invention, can include the display 3 having the digital receiving connector 40 receiving the digital video signal, according to a predetermined digital video interface, and the display module 30 displaying a picture thereon based on the digital video signal received from the digital receiving connector 40. The computer 1 may include the digital transmitting connector 20 connected to the digital receiving connector 40, and the graphic controller 10 transmitting the digital video signal, based on the digital video interface to the display 3 through the digital transmitting connector 20, so that configurations of the computer 1 and the display 3 are simplified, thereby reducing production costs and optimizing the picture quality by reducing losses in the video signal.

As described above, embodiments of the present invention provides a computer system having reduced production costs as a result of simplified configurations between the computer and a display, and picture quality is also optimized by decreasing potential losses in a video signal.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A computer system comprising:
a display comprising a digital receiving connector to receive a digital video signal, according to a predetermined digital video interface, and a display module displaying a picture directly from the received digital video signal;
a computer, separated from the display, comprising a digital transmitting connector, based on the predetermined digital video interface, and a graphic controller outputting the digital video signal through the digital transmitting connector; and
a digital video cable, comprising a first video connector connected to the digital receiving connector and a second video connector connected to the digital transmitting connector, to transmit the digital video signal from the computer to the display.

2. The computer system according to claim 1, wherein the digital video interface is one of an LVDS (low voltage differential signaling) interface and a TMDS (transmission minimized differential signaling) interface.

3. The computer system according to claim 2, wherein the graphic controller comprises a graphic processor outputting an analog video signal, and a digital transmitter converting the analog video signal output from the graphic processor into the digital video signal.

4. The computer system according to claim 3, wherein the computer comprises a display controller to control a display state of the picture displayed on the display module.

5. The computer system according to claim 4, wherein the display controller controls the display state of the picture displayed on the display module by adjusting characteristics of the digital video signal output from the graphic controller.

6. The computer system according to claim 5, wherein:
the display further comprises a power receiving connector to receive driving power for driving the display module;
the computer further comprises a power supplying connector connected to the power receiving connector and a display power supply to supply the driving power to the display through the power supplying connector; and
the computer system further comprises a power cable comprising a first power connector connected to the power receiving connector and a second power connector connected to the power supplying connector supplying the driving power between the computer to the display.

7. The computer system according to claim 6, wherein the display module comprises an LCD panel, a panel driver driving the LCD panel using the digital video signal, a backlight illuminating the LCD panel, and an inverter controlling light of the backlight based on a control signal from the computer; and
the display controller controls one of the graphic controller and the display power supply to output the control signal.

8. The computer system according to claim 6, wherein the display module comprises an LCD panel, a panel driver driving the LCD panel using the digital video signal, a backlight illuminating the LCD panel, and an inverter controlling an intensity of light from the backlight based on the driving power supplied from the computer; and
the display controller controls the driving power supplied from the display power supply to the inverter.

9. The computer system according to claim 4, wherein the display comprises a memory storing display identification information about the display, and
the computer and the display comprise at least two data lines to transmit the display identification information from the display to the computer.

10. The computer system according to claim 9, wherein the display identification information includes EDID (extended display identification) data.

11. The computer system according to claim 9, wherein the display controller controls the display state based on the display identification information received from the display.

12. The computer system according to claim 9, wherein the data line is allocated to corresponding pins of the digital transmitting connector and the digital transmitting connector.

13. The computer system according to claim 4, wherein the computer and the display comprise a data line to transmit information about a type of the display from the display to the computer.

14. The computer system according to claim 13, wherein the display controller controls the display state of a picture displayed on the display module according to the type of the display identified through the data line.

15. The computer system according to claim 13, wherein the data line is allocated to corresponding pins of the digital transmitting connector.

16. A computer system comprising:
a display comprising a low voltage differential signaling (LVDS) digital receiving connector to receive a LVDS digital video signal and a display module displaying a picture directly from the received LVDS digital video signal;
a computer, separated from the display, comprising an LVDS digital transmitting connector and a graphic controller outputting a corresponding digital video signal for the LVDS digital transmitting connector.

17. A computer system comprising:
a display comprising a transmission minimized differential signaling (TMDS) digital receiving connector to receive a TMDS digital video signal and a display module displaying a picture directly from the TMDS received digital video signal;
a computer, separated from the display, comprising a TMDS digital transmitting connector and a graphic controller outputting a corresponding digital video signal for the TMDS digital transmitting connector.
